(19) United States
(12) Patent Application Publication
(10) Pub. No.: US 2006/0139442 A1
(43) Pub. Date: Jun. 29, 2006

(54) Polygon mirror drive motor and laser mirror radiation device

(76) Inventor: Yukinobu Kurita, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/293,423

(22) Filed: Dec. 1, 2005

(30) Foreign Application Priority Data
Dec. 3, 2004 (JP) 2004-351697

(51) Int. Cl. B41J 27/00

(52) U.S. Cl. 347/261

(57) ABSTRACT

To enable preventing any unevenness in a synchronous signal itself from being caused owing to errors of placement of various components so as to deteriorate a detection accuracy; and by applying the above measures, consequently to provide a polygon mirror drive motor, with which it is possible to detect a signal for accurately controlling an emission timing of the laser beam to be emitted from a laser light source, as well as a laser mirror radiation device equipped with the polygon mirror drive motor described above. A frequency generation magnetized section, a frequency generation pattern, and a frequency dividing circuit are provided. The frequency dividing circuit outputs a signal, detected by the frequency generation pattern when the frequency generation magnetized section rotates, after the frequency dividing operation of the signal for the number of mirror planes of a polygon mirror.

### CROSS-REFERENCE TO RELATED APPLICATION

This application claims priority of Japanese Application No. 2004-351697, filed Dec. 3, 2004, the complete disclosure of which is hereby incorporated by reference.

### BACKGROUND OF THE INVENTION

a) Field of the Invention

The present invention relates to a polygon mirror drive motor for rotary driving of a polygon mirror to cyclically polarize a laser beam emitted from a laser light source, and a laser mirror radiation device equipped with the polygon mirror drive motor. Furthermore, the present invention especially relates to control of emission timing of the laser beam emitted from the laser light source.

b) Description of the Related Art

In general, laser mirror radiation devices equipped with polygon mirror (a turning mirror device having a plurality of mirror planes) are used for various applications such as laser printers, copying machines, car interval distance measuring systems, and so on. In the case of a laser printer illustrated by FIG. 10 for example, a beam emitted from a semiconductor laser 101 is made to be a parallel light through an image formation lens 102, and subsequently the beam is launched into a polygon mirror 104 rotated by a polygon mirror drive motor 103. Then, a reflected light from the polygon mirror 104 passes through an fθ lens 105, and a light spot formed on a photoconductive drum 106 repeats scanning operation on a scan surface at constant speed suitably. As a result, an electrostatic latent image is formed on the photoconductive drum 106 as required. In this regard, reference is made to Kokai (Japanese unexamined patent publication) No. 2003-312056 (see FIG. 2).

Operation mechanism of the light spot repeating its scanning operation on the scan surface at constant speed suitably is hereby described by referring to a drawing of FIG. 11. The polygon mirror 104 is fixed to a turning shaft 105 of the polygon mirror drive motor 103 such as, for example, a turning shaft of a three-phase stepping motor, into which 3-phase pulses are input. Then, in the case of the polygon mirror 104 having 6 reflecting planes, for example, on its circumference, for implementation of repeating the scanning operation on the scan surface at constant speed, it is required to emit laser beams from the semiconductor laser 101 in synchronization with motion of the 6 reflecting planes. Thus, a synchronous signal to be used for controlling the laser beam emission in synchronization with the number of the reflecting planes of the polygon mirror 104 is detected by a first sensor 107 (a hole IC) placed in the vicinity of a magnetic pole of a motor drive magnet (not shown in the figure) fixedly mounted in an arrangement with the polygon mirror drive motor 103 (Refer to FIG. 11). In the case of a motor drive magnet equipped with 12 magnetic poles for example, a synchronous signal of 6 pulses/revolution (6 P/R) is detected by the first sensor 107.

Furthermore, in order to implement repeating the scanning operation on the scan surface suitably, it is not sufficient to control the laser beam emission only in synchronization with the number of the reflecting planes of the polygon mirror 104 but it is also required to control the laser beam emission at a prescribed timing. Thus, an origin position signal (PG signal), to be used for controlling the laser beam emission at the prescribed timing, is detected by a second sensor 108 (a hole IC) placed facing a magnetic pole of a PG magnet (not shown in the figure) in an opposite position (refer to FIG. 11). The origin position signal is generally a signal of 1 pulse/revolution (1 P/R). Furthermore, the PG magnet may be placed fixedly, either being separated from the motor drive magnet or being united together with the motor drive magnet.

Thus, the conventional model laser printer is able to repeat the scanning operation on the scan surface at a suitable constant speed, through detection of the synchronous signal to be used for controlling the laser beam emission in synchronization with the number of the reflecting planes of the polygon mirror 104 as well as the origin position signal to be used for controlling the laser beam emission at the prescribed timing, by the first sensor 107 and the second sensor 108, respectively.

Actual signal waveforms of the synchronous signal and the origin position signal are now described by referring to FIG. 12 and FIG. 13. FIG. 12 is a block diagram to show an outline of an electrical construction of a drive circuit for driving the polygon mirror drive motor 103. Meanwhile, FIG. 13 shows waveform diagrams to illustrate voltage signal waveforms at corresponding positions in the block diagram shown by FIG. 12.

In FIG. 12, when an upper system, such as a microcomputer, for example, inputs 3-phase pulses (U, V, and W), whose phases are shifted for 120 degrees each other among them as FIG. 13A shows, into an input section 110, the 3-phase pulses (U, V, and W) are transferred to a main control circuit 111 composed of various electric elements such as resistors, condensers, ICs and so on. Then, the main control circuit 111 transfers the 3-phase pulses to a drive motor section 112 composed of a group of stator coils that are wound around stator cores. As a result, voltage signals (U′, V′, and W′) whose phases are shifted for 120 degrees each other among them are generated in the drive motor section 112, as FIG. 13B shows. Thus, eventually the polygon mirror drive motor 103 gets pulse-driven so as to turn at high speed.

Under such circumstances, the synchronous signal and the origin position signal are detected in the sections of the first sensor 107 and the second sensor 108. That is to say, an FG signal is detected by the first sensor 107, as shown in the upper part of FIG. 13C (6 pulses/revolution in FIG. 13C). Meanwhile, a PG signal is detected by the second sensor 108, as shown in the lower part of FIG. 13C (1 pulse/revolution in FIG. 13C).

As explained above, the conventional technique has made use of the synchronous signal and the origin position signal detected by the first sensor 107 and the second sensor 108, respectively, which are provided with the signal waveforrns shown in the upper and lower parts of FIG. 13C, for the purpose of suitably controlling the emission of the laser beam coming from the semiconductor laser 101.

Problem to Be Solved

However, there is a problem that the synchronous signal described above is easily and deleteriously affected by an error of placement at the time when the first sensor 107 is placed.

In other words, while the synchronous signal described above is detected by the first sensor 107, there exists a problem that, for example, a synchronous signal having a different pulse width is detected so that the synchronous signal itself will include unevenness so as to deteriorate the detection accuracy if the first sensor 107 is displaced from its originally prescribed position, in comparative relationships to the motor drive magnet fixedly placed on the circumference of the polygon mirror drive motor 103, when the first sensor 107 is placed onto a case.

Furthermore, such deterioration of the detection accuracy may be caused not only by the error of placement at the time when the first sensor 107 is placed, but also by other various errors, such as: an error of placement of the case, in which the first sensor 107 is placed, an error of placement of the motor drive magnet at the time when the motor drive magnet is mounted, an error of placement of each component, an error of relative positions of the mirror and magnet, and so on.

Thus, in the case of a conventional model polygon mirror drive motor where the synchronous signal is detected by the first sensor 107 alone, the errors described above may deteriorate the detection accuracy so that the laser radiation interval of each reflecting surface of the polygon mirror eventually becomes uneven. Then, once the laser radiation interval becomes uneven, it may become difficult to print a letter free from any disorder in the case where the laser mirror radiation device is used in a laser printer. Furthermore, in the case where the laser mirror radiation device is used in a car interval distance measuring system, it may become difficult to carry out measurement accurately.

### OBJECT AND SUMMARY OF THE INVENTION

The present invention has been developed in view of the problem described above, and the object of the present invention is to enable the prevention of any unevenness in the synchronous signal itself from being caused due to errors of placement of various components so as to deteriorate the detection accuracy, and consequently, to provide a polygon mirror drive motor, with which it is possible to detect a signal for accurately controlling the emission timing of the laser beam to be emitted from a laser light source, as well as a laser mirror radiation device equipped with the polygon mirror drive motor described above.

To solve the problem identified above; a frequency generation magnetized section, a frequency generation pattern, and a frequency dividing circuit are provided in the present invention, and the frequency dividing circuit outputs a signal detected by the frequency generation pattern at the time when the frequency generation magnetized section rotates, after the frequency dividing operation of the signal for the number of mirror planes of the polygon mirror.

### BRIEF DESCRIPTION OF THE DRAWINGS

In the drawings:

FIG. 1 is a cross section drawing of a polygon mirror drive motor relating to an embodiment of the present invention;

FIG. 2 is a top view of an FG pattern of a polygon mirror drive motor relating to an embodiment of the present invention;

FIG. 3 is a drawing to explain the way of detecting an FG signal;

FIG. 4 is a block diagram to show an outline of a drive circuit and its peripheral electrical construction to drive a polygon mirror drive motor relating to an embodiment of the present invention;

FIG. 5 is a circuit diagram to show a drive circuit and its peripheral electrical construction to drive a polygon mirror drive motor relating to an embodiment of the present invention;

FIG. 6 shows a couple of illustrations to explain an operation of detection of a synchronous signal to control an emission timing of a laser beam to be emitted from a laser light source;

FIG. 7 is a circuit diagram showing a modification of a drive circuit and its peripheral electrical construction to drive a polygon mirror drive motor relating to an embodiment of the present invention;

FIG. 8 shows a couple of waveforms of a PG signal detected by a hole element;

FIG. 9 is a circuit diagram showing another modification of a drive circuit and its peripheral electrical construction to drive a polygon mirror drive motor relating to an embodiment of the present invention;

FIG. 10 is a schematic drawing to show an outline of a conventional laser printer;

FIG. 11 is a schematic drawing to show an outline of a conventional polygon mirror drive motor;

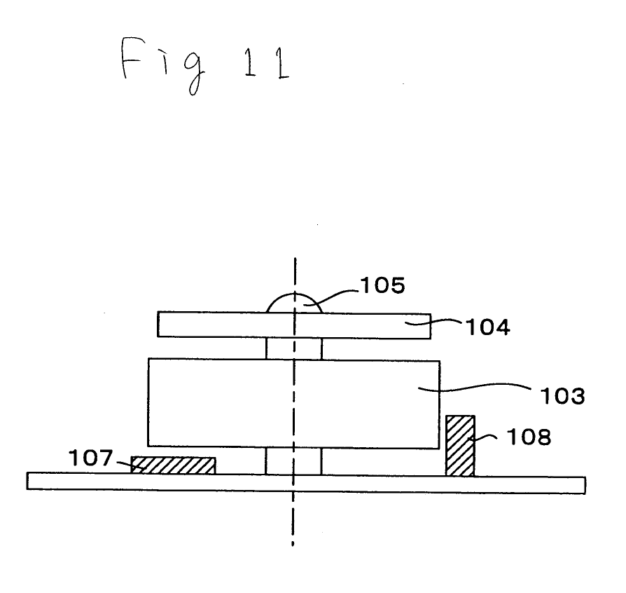

FIG. 12 is a block diagram to show an outline of an electrical construction of a drive circuit for driving a polygon mirror drive motor; and

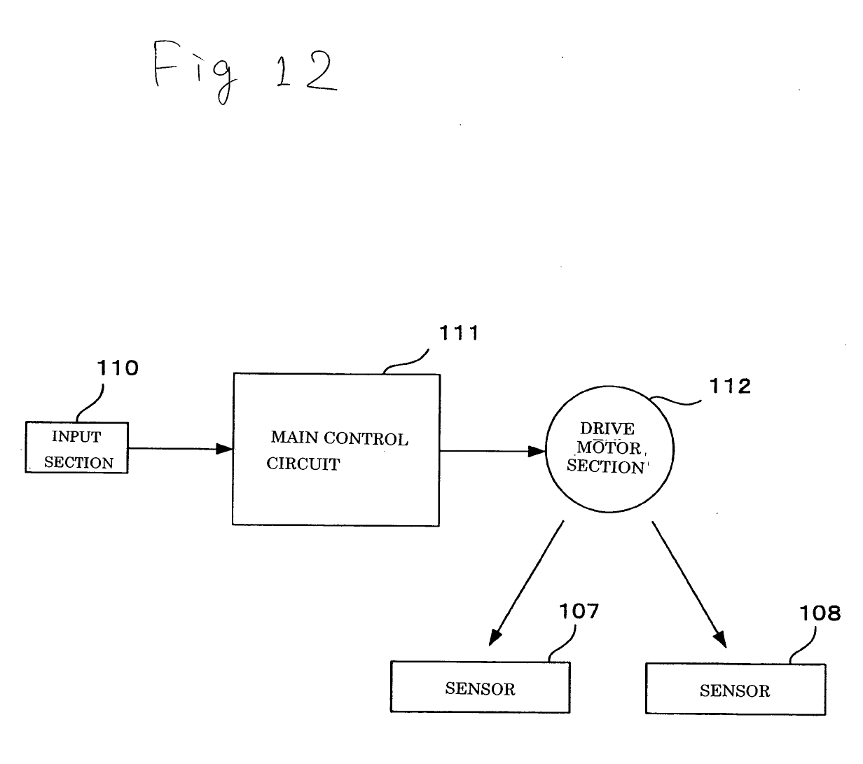

FIG. 13 shows a couple of waveform diagrams to illustrate voltage signal waveforms at corresponding positions in the block diagram shown by FIG. 12.

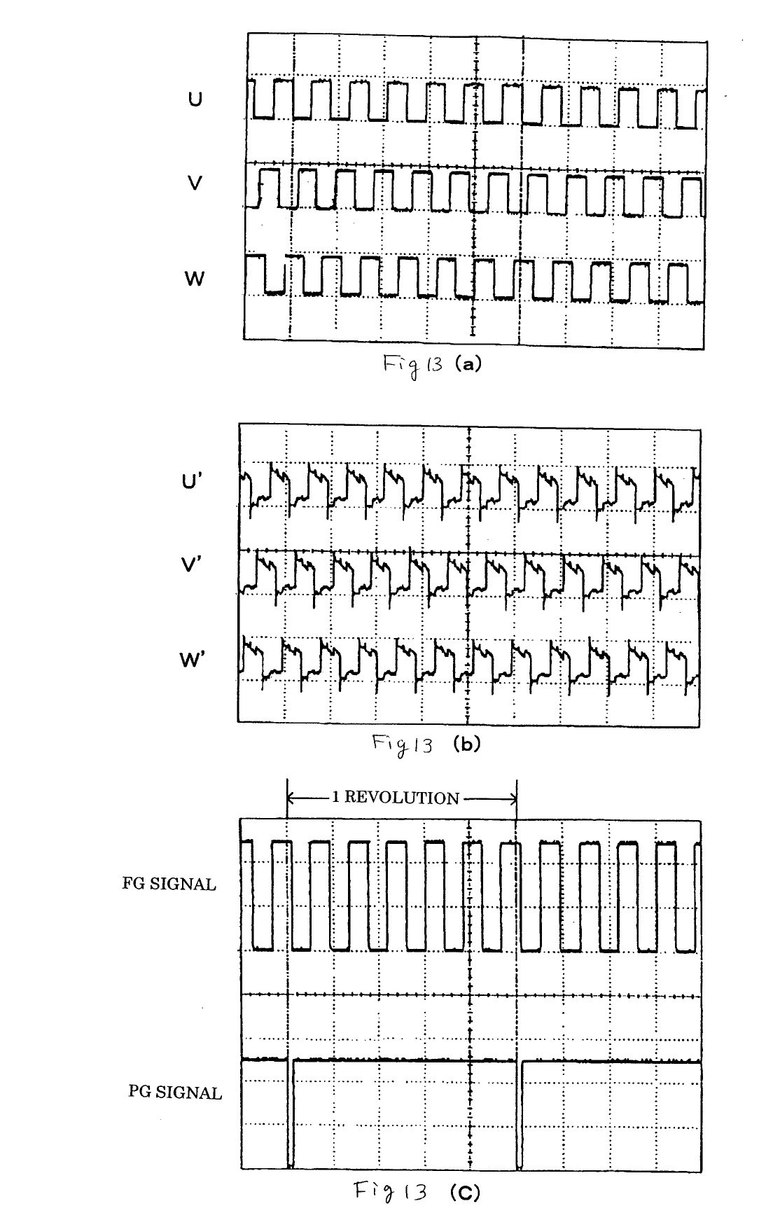

### DESCRIPTION OF THE PREFERRED EMBODIMENTS

A more specific description of the present invention follows.

(1) A polygon mirror drive motor for rotary driving of a polygon mirror, comprising: a frequency generation magnetized section, in which an N pole part and an S pole part are alternately placed being magnetized, and which rotates together with a rotor; a frequency generation pattern arranged in an opposite position so as to face the frequency generation magnetized section; and a frequency dividing circuit that outputs a signal after a frequency dividing operation of an input signal; wherein the frequency dividing circuit outputs a signal detected by the frequency generation pattern after the frequency dividing operation of the signal for the number of mirror planes of the polygon mirror.

According to the present invention, the polygon mirror drive motor for rotary driving of the polygon mirror comprises: the frequency generation magnetized section, in which the N pole part and the S pole part are alternately placed being magnetized, and which rotates together with the rotor; the frequency generation pattern arranged in the opposite position so as to face the frequency generation magnetized section; and the frequency dividing circuit that outputs the signal after the frequency dividing operation of the input signal; wherein the frequency dividing circuit outputs the signal detected by the frequency generation pattern (for example, 36 P/R) after the frequency dividing operation of the signal for the number of mirror planes of the polygon mirror (for example, dividing the frequency of 36 P/R by the frequency dividing operation of 1/6 so as to output the signal as 6 P/R). Therefore, regarding the magnetizing accuracy being secured at the frequency generation magnetized section, it is possible to obtain an accurate FG signal with less unevenness. As a result, it is possible to obtain a synchronous signal with less unevenness that is provided as an output after the frequency dividing operation of the accurate FG signal.

Since the synchronous signal has conventionally been detected by a sensor alone such as a hole IC or equivalent, unevenness might have been caused on the synchronous signal itself due to errors of placement of a case, a motor drive magnet, each component, and so on so that the detection accuracy might have deteriorated. However, according to the present invention, the synchronous signal is detected by making use of a frequency generation pattern formed on a substrate through etching process for example, it is possible to obtain the synchronous signal with less unevenness and eventually deterioration of the detection accuracy can be avoided.

Then, avoiding the deterioration of the detection accuracy makes it possible to prevent the laser radiation interval of each reflecting surface of the polygon mirror from becoming uneven. For example, in the case of a laser printer, it becomes possible to accurately print a letter free from any disorder. Moreover, in the case of a car interval distance measuring system, it is possible to carry out measurement accurately.

Furthermore, the present invention does not make use of a sensor alone such as a hole IC or equivalent but uses a frequency generation pattern having a plurality of generation wiring elements. Therefore, even when a pulse noise is caused, the noise gets cancelled to some extent in the signal detected by the frequency generation pattern at the time when the frequency generation magnetized section rotates so that it becomes possible to eventually improve the detection accuracy.

Moreover, in the case where the synchronous signal is detected by a semiconductor element such as a hole IC or equivalent, malfunction of the semiconductor element disables detection of the synchronous signal. However, in the case of the present invention, the frequency generation pattern formed on a substrate through etching process, etc. has less possibility of having malfunction, and probability of disabled detection of the synchronous signal can be decreased. As a result, reliability of the polygon mirror drive motor can be improved.

In addition, in the present invention, the FG signal to be generally used for keeping the motor rpm constant is not used as the synchronous signal as it is, but the synchronous signal is detected through the frequency dividing circuit. Therefore, it is possible to detect the synchronous signal for accurately controlling the emission timing of the laser beam to be emitted from a laser light source, while maintaining the revolution stability of the polygon mirror drive motor, and preventing any effects on W/F and jitter in view of the characteristics.

Any circuit can be used as the “frequency dividing circuit” of the present invention as far as it outputs the signal after a frequency dividing operation of an input signal. What can be named as the frequency dividing circuit includes, for example: a static frequency dividing circuit that uses a master slave T-FF (Toggle Flip-flop), a dynamic frequency dividing circuit composed of only a master gate, an up-counter circuit, a down-counter circuit, a BCD (Binary code decimal) counter circuit, and so on.

(2) The polygon mirror drive motor according to item (1) above, wherein the frequency dividing circuit is equipped with a logic circuit, in which a plurality of D-type flip-flop circuits are connected in series, and in the logic circuit, data according to the signal detected by the frequency generation pattern are shifted cyclically so as to output the signal after the frequency dividing operation.

According to the present invention, the frequency dividing circuit described above is equipped with a logic circuit, in which a plurality of D-type flip-flop circuits are connected in series, and in the logic circuit, data according to the signal detected by the frequency generation pattern are shifted cyclically so as to output the signal after the frequency dividing operation. Therefore, the frequency dividing operation can be carried out by a simple and inexpensive logic circuit for the FG signal detected by the frequency generation pattern, and consequently it is possible to obtain a synchronous signal with less unevenness.

(3) The polygon mirror drive motor according to item (1) or item (2) above, wherein the polygon mirror drive motor further comprises: a position detection magnetized section placed onto the rotor; a position detection device arranged so as to face the position detection magnetized section in an opposite position; and a timing circuit that controls start timing of the frequency dividing operation of the frequency dividing circuit according to a signal detected by the position detection device.

According to the present invention, the polygon mirror drive motor described above further comprises: a position detection magnetized section placed onto the rotor; a position detection device arranged so as to face the position detection magnetized section in an opposite position; and a timing circuit that controls start timing of the frequency dividing operation of the frequency dividing circuit according to a signal detected by the position detection device. Therefore, the FG signal described above can be regularized at the timing as required.

That is to say, the timing circuit is provided while having a signal detected by the position detection device, i.e., an origin position signal (PG signal) as an input, in order to output a clock signal for controlling the start timing of the frequency dividing operation of the frequency dividing circuit. Therefore, the frequency dividing circuit starts the frequency dividing operation at a most suitable timing. As a result, it is possible to control the laser beam emission at a most suitable timing, and consequently scanning operation can suitably be repeated on a scan surface.

Any device can be used as the “timing circuit” of the present invention as long as it outputs a clock signal for controlling the start timing of the frequency dividing operation of the frequency dividing circuit, while having an origin position signal as an input. Various devices such as a passive element, an active element, a delay element, an IC, and so on can be used for the purpose.

The polygon mirror drive motor according to item (3) above, wherein the timing circuit is composed of a differential circuit with a resistor and a condenser.

According to the present invention, the timing circuit described above is composed of a differential circuit with a resistor and a condenser. Therefore, it is possible to manufacture the timing circuit simply and inexpensively. As a result, the FG signal can be regularized simply and inexpensively at the timing as required.

A laser mirror radiation device, comprising the polygon mirror drive motor according to any of item (1) through item (4) described above.

According to the present invention, the laser mirror radiation device, comprising the polygon mirror drive motor described above, can be provided. Therefore, it becomes possible to detect a signal for suitable control of emission timing of a laser beam emitted from a laser light source.

A polygon mirror drive motor for rotary driving of a polygon mirror, comprising: a frequency generation magnetized section, in which an N pole part and an S pole part are alternately placed being magnetized, and which rotates together with a rotor; and a frequency generation pattern arranged in an opposite position so as to face the frequency generation magnetized section; wherein a frequency of the signal detected by the frequency generation pattern is equal to the number of the mirror planes of the polygon mirror.

According to the present invention, the polygon mirror drive motor for rotary driving of the polygon mirror comprises: the frequency generation magnetized section, in which the N pole part and the S pole part are alternately placed regarding magnetization, and which rotates together with the rotor; and the frequency generation pattern arranged in the opposite position so as to face the frequency generation magnetized section; wherein the frequency of the signal detected by the frequency generation pattern is equal to the number of the mirror planes of the polygon mirror. Therefore, as long as the magnetizing accuracy is secured at the frequency generation magnetized section, it is possible to obtain an accurate FG signal with less unevenness whose frequency is equal to the number of the mirror planes of the polygon mirror. As a result, it is possible to avoid the deterioration of the detection accuracy, and still further prevent the laser radiation interval of each reflecting surface of the polygon mirror from becoming uneven.

The description above stating that the frequency of the signal detected by the frequency generation pattern is “equal to the number of the mirror planes of the polygon mirror” means that, in the case of a polygon mirror equipped with 6 mirror planes for example, a signal having a frequency of 6 P/R is detected by the frequency generation pattern.

Advantageous Effect of the Invention

As described above, in a polygon mirror drive motor and a laser mirror radiation device comprising the polygon mirror drive motor, relating to the present invention; a synchronous signal with less unevenness is obtained by making use of a signal (FG signal) detected by the frequency generation pattern, while being output after the frequency dividing operation of the FG signal. Therefore, it is possible to avoid deterioration of the detection accuracy due to errors of placement of a case, a motor drive magnet, each component, and so on. Consequently, it is possible to prevent the laser radiation interval of each reflecting surface of the polygon mirror from becoming uneven.

### DESCRIPTION OF THE PREFERRED EMBODIMENTS

A preferred embodiment of the present invention is described directly below with reference to the accompanying drawings.

The Mechanical Construction

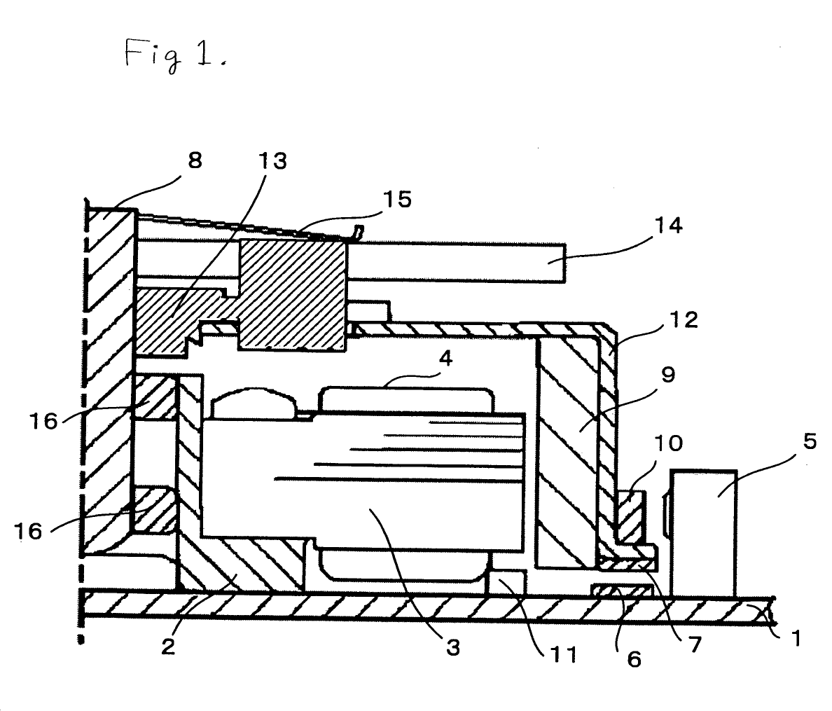

FIG. 1 is a cross section drawing of a polygon mirror drive motor relating to an embodiment of the present invention. FIG. 1 shows only the right half side of a turning shaft 8 as a matter of convenience.

In FIG. 1, a bearing housing 2 being almost cylindrical and equipped with a flange is mounted on a substrate 1. A stator core 3 having a plurality of protrusion pole parts is assembled onto an outer side of the bearing housing 2, and eventually the stator core 3 and the bearing housing 2 are fixed onto the substrate 1. Each protrusion pole part of the stator core 3 is provided with a drive coil 4 wound to be energized and controlled.

Inside the bearing housing 2, two shaft bearings 16 are placed while being supported so as to enable their turning operation freely. At a top end of the turning shaft 8 protruding from the bearing housing 2, a cup-shaped rotor case 12 is fixed via a hub table 13 in such a manner that the rotor case 12 is able to turn together with the turning shaft 8. A polygon mirror 14 is mounted onto the hub table 13, and the polygon mirror 14 is pressed against the hub table 13 so as to be retained there by a retaining spring 15 fixed to the top end of the turning shaft 8 with a screw or equivalent.

Inside a circumferential wall of the rotor case 12, a motor drive magnet 9 is placed, and the motor drive magnet 9 faces an outer circumferential surface of the protrusion pole parts of the stator core 3 with a prescribed clearance. Therefore, when the drive coil 4 is energized and controlled, the motor drive magnet 9 is urged so that the rotor case 12 turns.

Outside the circumferential wall of the rotor case 12, a PG magnet 10 is provided for detecting an origin position (for the purpose of indexing operation), while facing a hole IC 5 with a prescribed clearance. The hole IC 5 is used to detect an origin position signal for controlling the laser beam emission at the prescribed timing.

At a bottom part of the circumferential wall of the rotor case 12, a flange section is provided. At a bottom surface of the flange section, an FG magnet 7 for frequency generation is placed, and the FG magnet 7 faces an FG pattern 6 formed on the substrate 1 with a prescribed clearance.

On the substrate 1, the prescribed number of hole elements 11 (for example 3 elements) are mounted, and the hole elements 11 sense the magnetic flux of the motor drive magnet 9 to carry out switching operation of the current to the motor through a circuit on the substrate 1.

In the case of a conventional polygon mirror drive motor, a synchronous signal to be used for controlling the laser beam emission in synchronization with the number of the reflecting planes of the polygon mirror 14 is detected by sensors such as the hole elements 11 described above. However, in the case of a polygon mirror drive motor relating to the embodiment of the present invention, the synchronous signal is detected through the FG pattern 6 formed on the substrate 1.

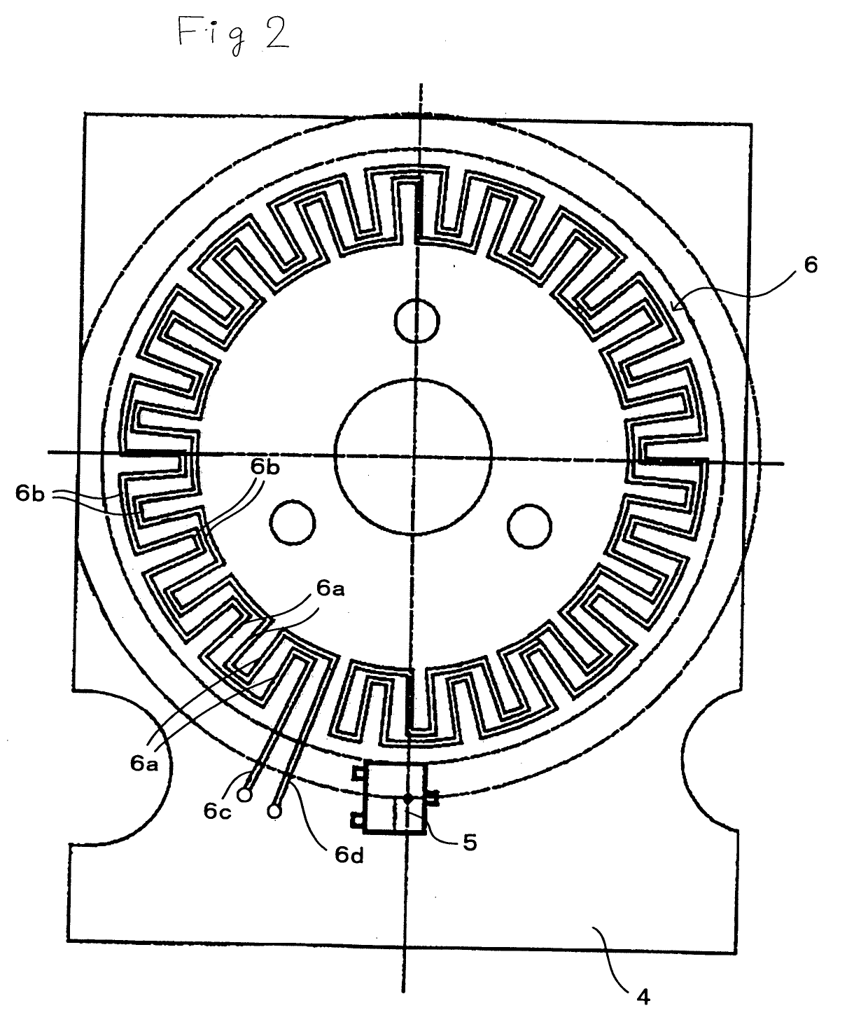

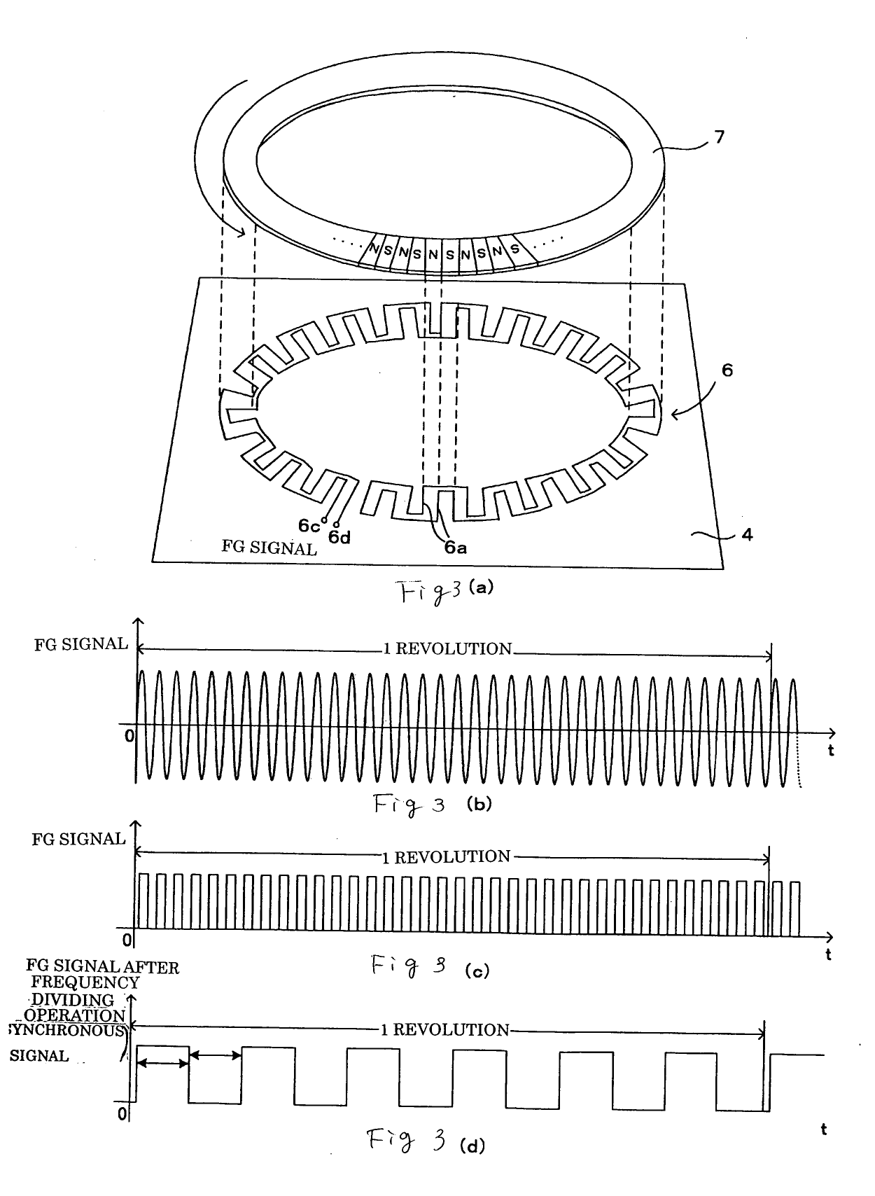

More specific explanation is given by referring to FIG. 2 and FIG. 3. FIG. 2 is a top view of the FG pattern 6 of the polygon mirror drive motor relating to the embodiment of the present invention.

In the FG pattern 6 of FIG. 2 formed on the substrate 1 by etching manufacturing, an AC voltage is generated in proportion to the motor rpm when the rotor case 12 turns. Usually, the motor speed is controlled by making use of a frequency of the AC voltage. However, in the present embodiment, detection of the synchronous signal is also carried out by making use of the frequency of the AC voltage.

The FG pattern 6 is composed of a plurality of patterns of generation wiring element 6a being formed in radial directions, and a plurality of patterns of connection wiring elements 6b, each of which connects an end of a generation wiring element 6a to an end of another generation wiring element 6a. An end of a generation wiring element 6a on the inner circle side is connected to either an end of another neighboring generation wiring element 6a on the inner circle side, or an end of a generation wiring element 6a positioned beyond two generation wiring elements 6a on the inner circle side, by using a connection wiring element 6b. Furthermore, an end of a generation wiring element 6a on the outer circle side is connected to either an end of another neighboring generation wiring element 6a on the outer circle side, or an end of a generation wiring element 6a positioned beyond two generation wiring elements 6a on the outer circle side, by using a connection wiring elements 6b. Consequently, the FG pattern 6, as a whole, is formed to be a rectangular wave; and it is in appearance laid out in a circular form.

One end of the FG pattern 6 is formed as a first lead wire 6c being extended in an outer radial direction, while the other end of the FG pattern 6 is also formed as a second lead wire 6d being extended in an outer radial direction. When the FG magnet 7 placed at the bottom surface of the flange section of the rotor case 12 rotates, the FG signal is detected through both the ends of the first lead wire 6c and the second lead wire 6d.

FIG. 3 is a drawing to explain the way of detecting the FG signal. In FIG. 3A, any other elements except the FG magnet 7 and the FG pattern 6 are omitted for convenience of explanation. Furthermore, the FG magnet 7 rotates in the CCW direction in FIG. 3. Moreover, the FG magnet 7 includes 72 magnetic poles in total, and each magnetic pole is magnetized in its thickness direction (in the vertical direction in FIG. 3). Still further, there exist 72 generation wiring elements 6a in total in the FG pattern 6, and each clearance between two neighboring generation wiring elements 6a of the FG pattern is almost equal to the width of each magnetic pole of the FG magnet 7 through entire circumference so as to implement frequency power generation by the FG pattern 6.

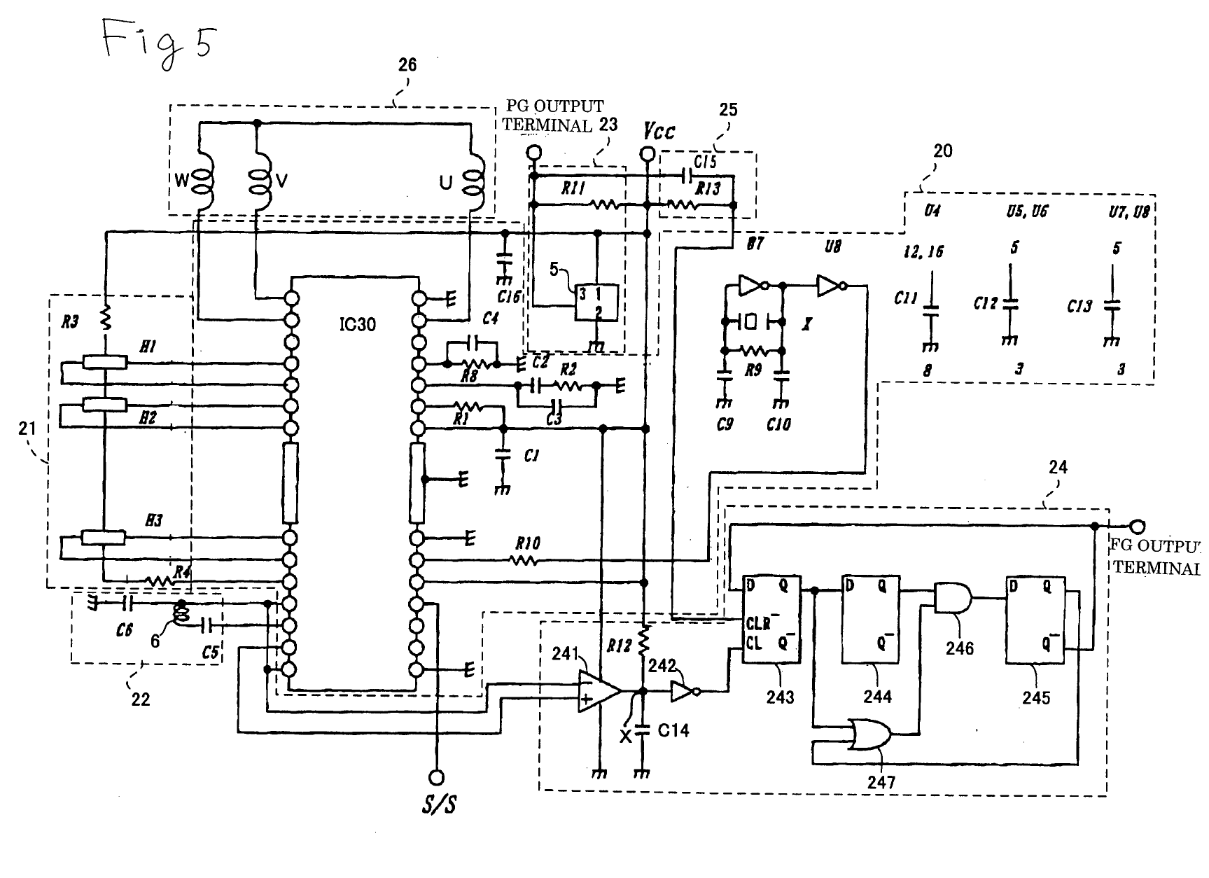

In FIG. 3, when the FG magnet 7 rotates above the FG pattern 6 formed on the substrate 1, induced electromotive force is generated at each generation wiring element 6a of the FG pattern 6 by electromagnetic interaction between the FG magnet 7 and the FG pattern 6 so that the FG signal is detected from both the ends of the first lead wire 6c and the second lead wire 6d (FIG. 3B). While the FG magnet 7 turns around in one complete circle, electric power generation is carried out 36 times, and therefore the FG signal becomes a sine wave with 36 times of electric power generation per one revolution (any distortion is omitted). Then, through a signal processing operation of a frequency dividing circuit 24 described later (FIG. 5), the FG signal is converted into a voltage pulse signal of 36 pulses/revolution (FIG. 3C), and still further into another voltage pulse signal of 6 pulses/revolution (FIG. 3D).

As described above, in the case of the polygon mirror drive motor relating to the embodiment of the present invention, the FG signal detected by the FG pattern 6 is made use of for obtaining the synchronous signal that FIG. 3C shows. Next, the following sections describe a drive circuit and its peripheral electrical construction in order to drive the polygon mirror drive motor relating to the embodiment of the present invention, including the conversion from FIG. 3B to FIG. 3C.

The Electrical Construction

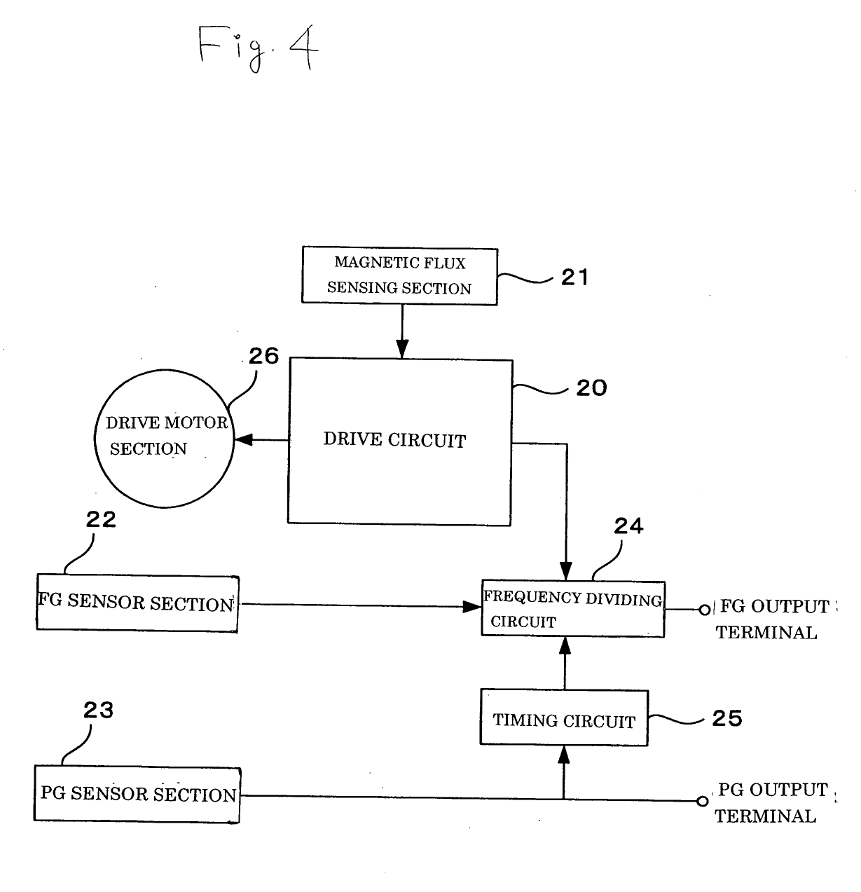

FIG. 4 is a block diagram to show an outline of the drive circuit and its peripheral electrical construction to drive the polygon mirror drive motor relating to the embodiment of the present invention. In the case of the polygon mirror drive motor relating to the embodiment of the present invention, the motor turning speed is suitably controlled by the full-wave soft switching current drive method. The full-wave soft switching current drive method is a method in which an energizing signal provided with a waveform having softened inflection points is used as an energy-switching signal.

In FIG. 4, the drive circuit and its peripheral electrical construction to drive the polygon mirror drive motor relating to the embodiment of the present invention include: a drive motor section 26 composed of a group of coils wound around stator cores; a drive circuit 20 to control energizing the drive motor section 26; a magnetic flux sensing section 21 composed of three hole elements or equivalent to sense the magnetic flux of the motor drive magnet 9; an FG sensor section 22 to detect the FG signal; a PG sensor section 23 to detect the PG signal; the frequency dividing circuit 24 to implement the frequency dividing operation for generating 1/n frequency out of an input pulse; and a timing circuit 25 to supply a control signal to the frequency dividing circuit 24 for controlling the timing of the frequency dividing operation according to the PG signal from the PG sensor section 23.

A brief explanation of the operation of the circuit shown in FIG. 4 is described below: When the group of coils wound around the stator cores in the drive motor section 26 are controlled so as to be energized by the drive circuit 20, the motor drive magnet 9 mounted on the rotor (rotor case 12) is urged by electromagnetic interaction to turn the rotor. Subsequently, when the rotor turns, the FG signal is detected by the FG pattern 6 in the FG sensor section 22 (refer to FIG. 3B), as described above. The FG signal detected in the FG sensor section 22 is input into the frequency dividing circuit 24. Then, the FG signal having its 1/n frequency after the frequency dividing operation in the frequency dividing circuit 24 is eventually output (refer to FIG. 3D).

Then, by detecting the FG signal having its 1/n frequency after the frequency dividing operation as a synchronous signal at FG output terminals, it becomes possible to control the emission of the laser beam to be emitted from a laser light source in synchronization with the number of the reflecting planes of the polygon mirror.

Furthermore, the PG signal detected by the PG sensor section 23 (hole IC 5) is input into the frequency dividing circuit 24 through the timing circuit 25. Then, it becomes possible to control the emission timing, as required, of the laser beam to be emitted from the laser light source by making use of the PG signal input into the frequency dividing circuit 24.

The electrical construction, the summary of which is described above by referring to the block diagram of FIG. 4, is now explained in detail by making use of a circuit diagram of FIG. 5. FIG. 5 is a circuit diagram to show the drive circuit and its peripheral electrical construction to drive the polygon mirror drive motor relating to the embodiment of the present invention. A circuit pertinent to its corresponding block in the block diagram of FIG. 4 is referred to with the same reference number as shown in FIG. 4.

As briefly explained above by making use of the block diagram of FIG. 4, the circuit diagram of FIG. 5 includes: the drive motor section 26, the drive circuit 20, the magnetic flux sensing section 21, the FG sensor section 22, the PG sensor section 23, the frequency dividing circuit 24, and the timing circuit 25.

The drive motor section 26 includes the group of coils, U, V, and W that are star-connected, and wound around the stator cores. Then, each of the group of coils, U, V, and W, is connected to a prescribed pin of an IC 30.

The FG sensor section 22 includes: the FG pattern 6 (refer to FIG. 2) composed of the generation wiring elements 6a and the connection wiring elements 6b, a condenser C5, and another condenser C6. In the case of using the FG pattern 6 shown in FIG. 2 for example; when the FG magnet 7 equipped with 72 magnetic poles turns around in one complete circle, a sine wave with 36 times of electric power generation per one revolution (any distortion is omitted) is detected. Then, the sine wave is input into the prescribed pins of the IC 30.

The PG sensor section 23 includes the hole IC 5 for detecting a PG signal, and a resistor R 11. Furthermore, the sensor section 23 is provided with a PG output terminal to output the PG signal detected by the hole IC 5, as a PG output as it is.

The frequency dividing circuit 24 includes: a comparator 241, a NOT gate 242, a first D-type flip-flop (DFF) 243, a second D-type flip-flop (DFF) 244, a third D-type flip-flop (DFF) 245, an AND gate 246, an OR gate 247, a resistor R 12, and a condenser 14. Although D-type flip-flops are used in this example, it is also possible to use another type of flip-flops instead, such as JK-type flip-flops and so on.

When a sine wave with 36 times of electric power generation per one revolution (refer to FIG. 3B) is detected at the FG pattern 6, a voltage pulse signal of 36 pulses/revolution (refer to FIG. 3C) is generated at a node point X of the frequency dividing circuit 24. That is to say; the sine wave with 36 times of electric power generation per one revolution (refer to FIG. 3B) detected in the FG sensor section 22 is converted by the comparator 241 into the voltage pulse signal of 36 pulses/revolution (refer to FIG. 3C), which reaches the node point X. Then, the voltage pulse signal at the node point X has its H-level and L-level reversed by the NOT gate 242, and subsequently the reversed signal is input into a CL terminal of the first D-type flip-flop (DFF) 243.

Each of the first D-type flip-flop (DFF) 243 through the third D-type flip-flop (DFF) 245 is provided with a D-terminal, a Q-terminal, and a CL-terminal; and each D-type flip-flop has a function (edge trigger function) to transmit the status of its D-terminal (H-level or L-level) at the time when the clock pulse signal input into the CL terminal rises (i.e., at the time when the voltage pulse signal at the node point X falls, due to the existence the NOT gate 242) as an output to the Q-terminal. At any other timing, the status of the preceding data output is maintained. When the level of the CLR-terminal of the first D-type flip-flop (DFF) 243 changes from H-level to L-level, a clearing function operates so as to reset the level of the CLR-terminal from L-level to H-level and start the frequency dividing.

In the frequency dividing circuit 24 shown in FIG. 5, the Q-terminal of the first D-type flip-flop (DFF) 243 is connected to the D-terminal of the second D-type flip-flop (DFF) 244, and it is further connected to the AND gate 246 through the OR gate 247. The Q-terminal of the second D-type flip-flop (DFF) 244 is connected to the D-terminal of the third D-type flip-flop (DFF) 245 through the AND gate 246. The Q-terminal of the third D-type flip-flop (DFF) 245 is connected to the OR gate 247, and meanwhile the Q-terminal of the third D-type flip-flop (DFF) 245 is fed back to the D-terminal of the first D-type flip-flop (DFF) 243 and it is also connected to an FG output terminal to enable being output as an FG output signal.

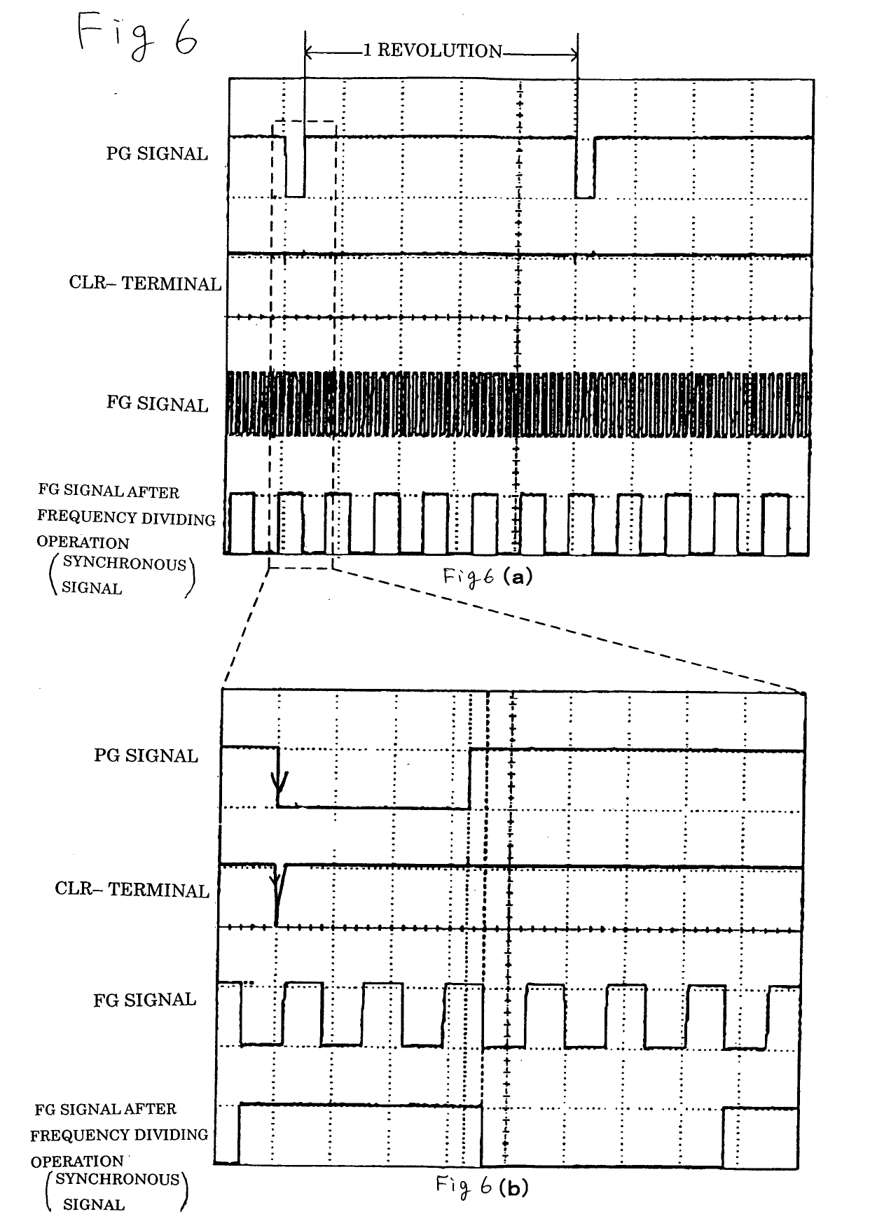

By using the frequency dividing circuit 24 described above, an FG signal after the frequency dividing operation of 1/6 on the voltage pulse signal at the node point X is detected as a synchronous signal to control the emission timing of the laser beam to be emitted from the laser light source at the FG output signal. More concrete explanation is given by referring to FIG. 6, which shows a couple of illustrations to explain the operation of detection of the synchronous signal to control the emission timing of the laser beam to be emitted from the laser light source. FIG. 6B shows an enlarged view of a part of FIG. 6A surrounded by the dotted line.

In FIG. 6A, the top part shows a voltage waveform of the PG signal, the second part from the top shows a voltage waveform at the CLR-terminal, the third part from the top shows a voltage waveform of the FG signal at the node point X, and the bottom part shows a voltage waveform at the FG output terminal (namely, a voltage waveform of the synchronous signal).

According to FIG. 6A, it is understood that the synchronous signal (the bottom part of FIG. 6A) is 6 P/R when the FG signal (the third part from the top of FIG. 6A) is 36 P/R. That is to say, it is understood that the synchronous signal is generated by the frequency dividing operation of 1/6 on the voltage pulse signal at the node point X. Therefore, it is realized that, in the case of a polygon mirror provided with 6 reflecting planes, the emission timing of the laser beam to be emitted from the laser light source can be controlled in synchronization with the polygon mirror's turning operation by making use of the synchronous signal.

Thus, being different from any conventional method where a 6 P/R synchronous signal is detected directly in the beginning by using a hole IC or equivalent, the present invention implements detection of the FG signal of 36 P/R, for example, at first. Then, the synchronous signal of 6 P/R is generated from the FG signal. Therefore, it is possible to prevent the synchronous signal itself from having unevenness so as to deteriorate the detection accuracy.

Referring to FIG. 6B showing the enlarged view of the part of FIG. 6A surrounded by the dotted line, at the moment when the PG signal falls from H-level to L-level (at the moment when the voltage waveform at the CLR-terminal also falls from H-level to L-level), the clearing function operates in the first D-type flip-flop (DFF) 243. Then, subsequently in a few micro-seconds (in 10 micro-seconds, for example), the CLR-terminal becomes reset to change from L-level to H-level by the function of the timing circuit 25, and the frequency dividing operation starts.

Thus, according to the present invention, while the PG signal detected by the PG sensor section 23 (refer to FIG. 5) is input into the CLR-terminal of the first D-type flip-flop (DFF) 243 through the timing circuit 25, the start timing of the frequency dividing operation can be controlled, and consequently it is possible to control the emission timing, as required, of the laser beam to be emitted from the laser light source. In the timing circuit 25, the relationship between C15 and R13 is made so as to meet the formula, for example; T (Time constant)=0.7×C15×R13. Furthermore it is also possible to output a pulse signal as the output signal from the timing circuit 25.

Further Modifications

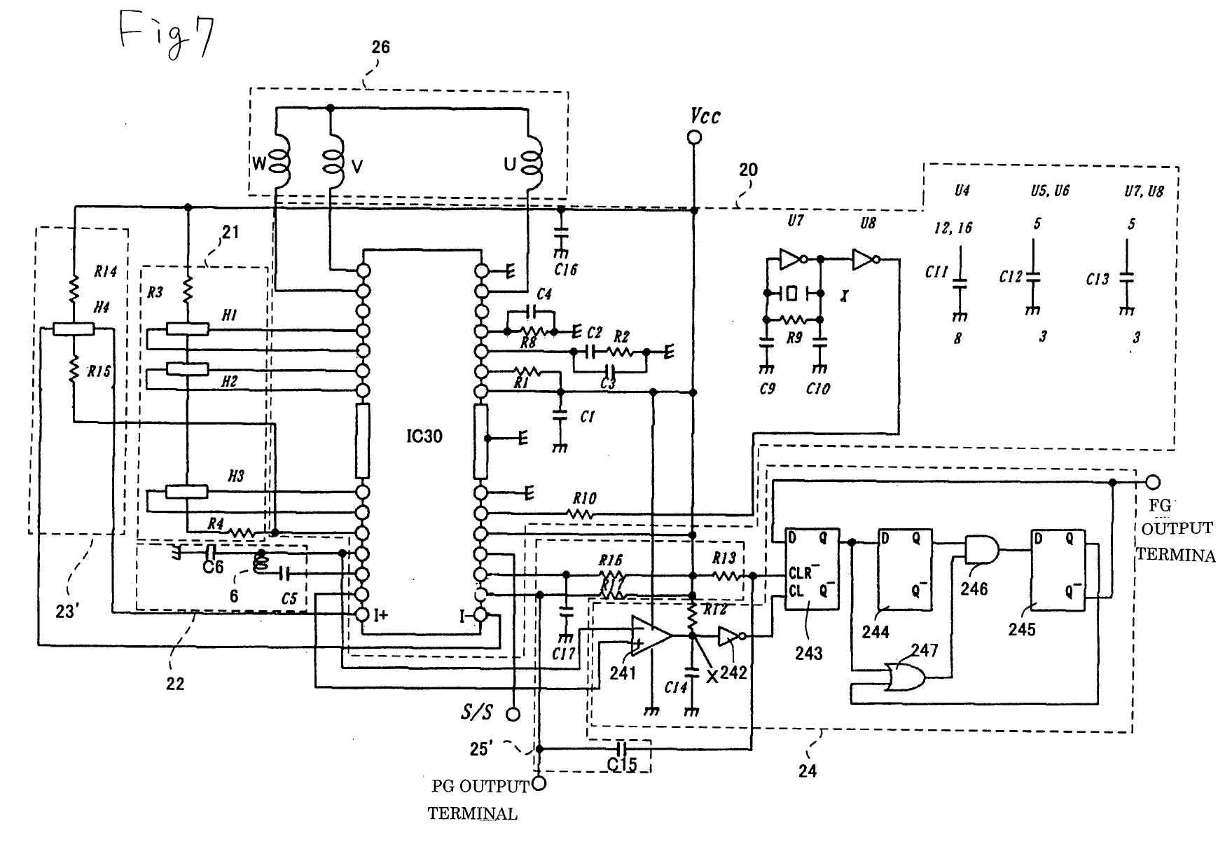

FIG. 7 is a circuit diagram showing a modification of the drive circuit and its peripheral electrical construction to drive the polygon mirror drive motor relating to an embodiment of the present invention. A circuit section pertinent to its corresponding section surrounded with a dotted line in the circuit diagram of FIG. 5 is referred to with the same reference number as shown in FIG. 5.

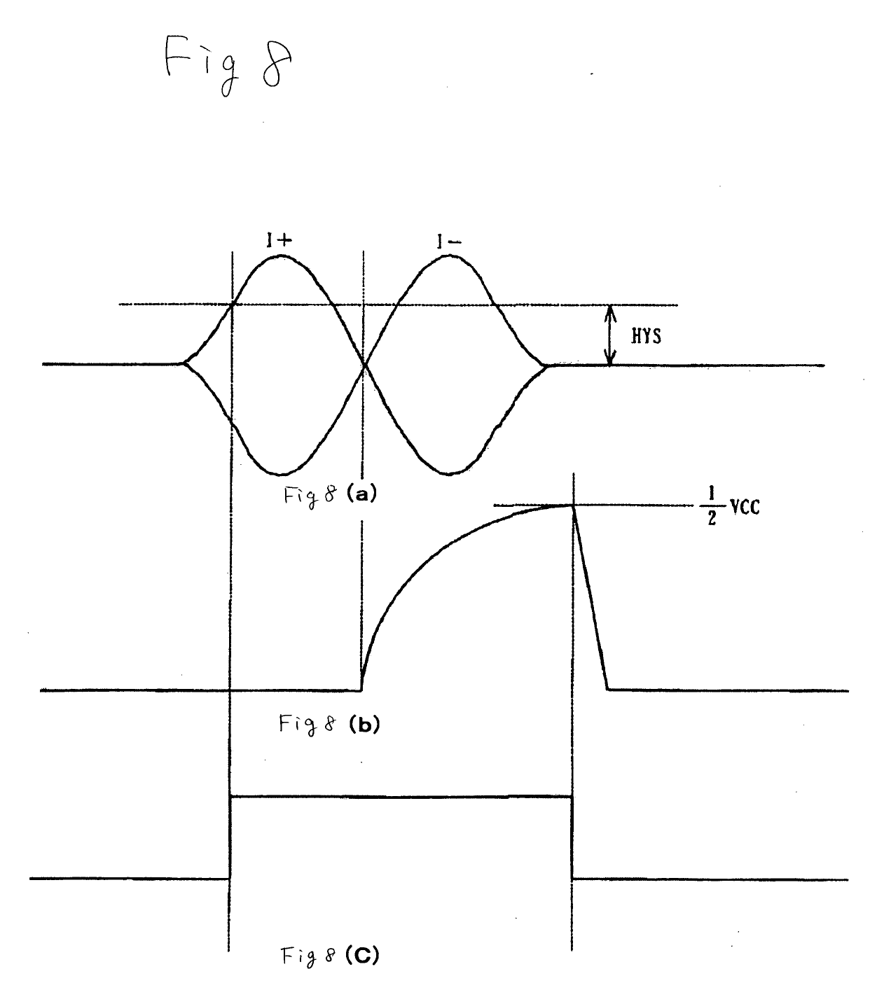

In comparison with the electrical construction shown in FIG. 5, the modification of electrical construction shown in FIG. 7 includes its constituent elements and circuit arrangement, which are different from those of the PG sensor section 23. That is to say, in FIG. 7, a PG sensor section 23′ includes, a hole element H4, a bias resistor R14, and another bias resistor R15; and both the ends of the hole element H4 are connected to prescribed pins of the IC 30 of the drive circuit 20. A PG signal (FIG. 8A) detected by the hole element H4 passes through a Schmidt trigger circuit inside the IC 30 to get converted into a signal shown by FIG. 8B, and further passes through a time constant circuit inside the IC 30 to get converted into a PG signal having a pulse waveform that FIG. 8C shows. Then, the PG signal having a pulse waveform shown by FIG. 8C leaves the IC 30 and passes through a timing circuit 25′, and then gets input into the CLR-terminal of the first D-type flip-flop (DFF) 243 of the frequency dividing circuit 24. Incidentally, in FIG. 8A; the signal waveform at the I+ pin of the IC 30 is shown as “I+”, while the signal waveform at the I− pin of the IC30 is shown as “I−”

Thus, even in the case of using not a hole IC but a hole element in the PG sensor section 23′, it is still possible to control the start timing of the frequency dividing operation, and eventually to control the emission timing, as required, of the laser beam to be emitted from the laser light source.

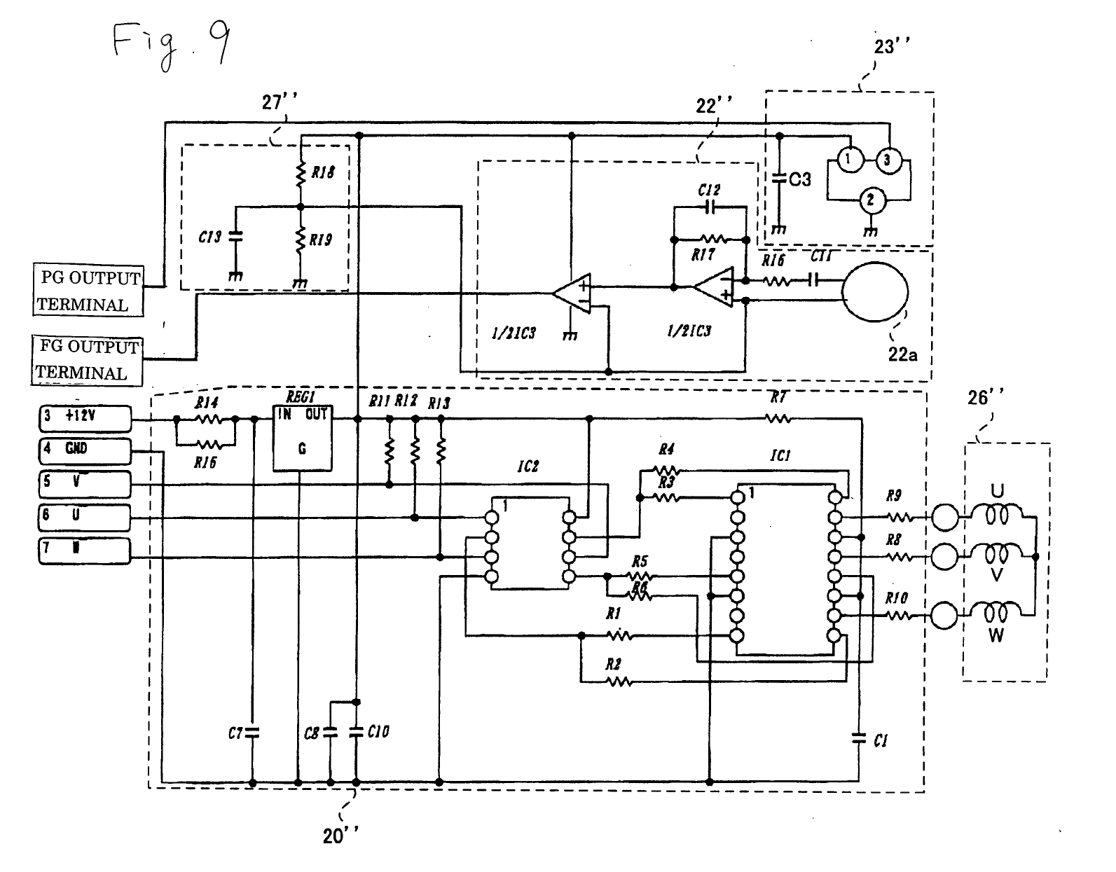

FIG. 9 is a circuit diagram showing another modification of the drive circuit and its peripheral electrical construction to drive the polygon mirror drive motor relating to an embodiment of the present invention. In the embodiment, the present invention is applied to a brushless motor for a FDD, but it is also possible to apply the present invention to a different type of motor, for example, such as a stepping motor as shown in FIG. 9. Incidentally, a circuit section pertinent to its corresponding section surrounded with a dotted line in the circuit diagram of FIG. 5 is referred to with the same reference number as shown in FIG. 5.

A circuit diagram of FIG. 9 is composed of a drive motor section 26″, a drive circuit 20″, an FG sensor section 22″, a PG sensor section 23″, and a bias section 27″. Then, in the FG sensor section 22″ (FG detecting section 22a), an FG signal of 6 P/R being equal to the number of mirror planes of the polygon mirror (6 mirror planes in this case) is detected. More specifically, if an FG magnet 7 having 12 magnetic poles in total and an FG pattern 6 having 12 generation wiring elements 6a are used, an FG signal of 6 P/R is detected.

Then, taking the FG signal out of the FG output terminal as a synchronous signal makes it possible to control the emission timing of the laser beam to be emitted from the laser light source in synchronization with the polygon mirror's turning operation. Furthermore, taking out a PG signal detected in the PG sensor section 23″ through the PG output terminal makes it possible to control the emission timing, as required, of the laser beam to be emitted from the laser light source.

Thus, if the present invention is applied to a stepping motor, reducing the number of required components contributes to cost reduction, and moreover it becomes possible to suitably control the emission timing of the laser beam.

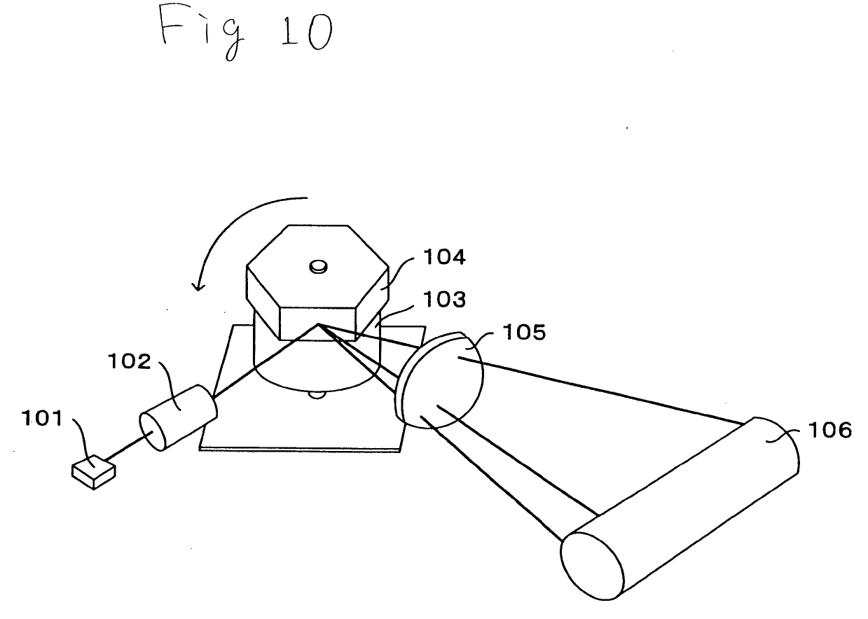

As a laser mirror radiation device relating to the embodiment of the present invention, various devices and tools can be named, such as the laser printer equipped with the polygon mirror drive motor as described above (refer to FIG. 10), other copying machines, car interval distance measuring systems, and so on. Furthermore, although the number of FG pulses is principally 36 in the embodiment, the same effect can be realized if the number of FG pulses is an integral multiple of 6. For example; if the number of FG pulses is 12, 24, 30, 48, or 60, the frequency dividing operation is carried out by dividing with 2, 4, 5, 8, or 12, respectively. Still further, although the number of mirror planes is principally 6 in the embodiment, the same concept can be applied even in the case of another multiple number of mirror planes.

### INDUSTRIAL APPLICABILITY

A polygon mirror drive motor and a laser mirror radiation device equipped with the polygon mirror drive motor relating to the present invention are valuable, since they can avoid deterioration of the detection accuracy due to errors of placement of a case, a motor drive magnet, each component, and so on; and eventually, it is possible to prevent the laser radiation interval of each reflecting surface of the polygon mirror from becoming uneven.

While the foregoing description and drawings represent the present invention, it will be obvious to those skilled in the art that various changes may be made therein without departing from the true spirit and scope of the present invention.

### REFERENCE NUMERALS

1. substrate
2. bearing housing
3. stator core
4. drive coil
5. hole IC
6. FG pattern
6a. generation wiring element
6b. connection wiring element
6c. and 6d. first lead wire and second lead wire
7. FG magnet
8. turning shaft
9. motor drive magnet
10. PG magnet
11. hole element
12. rotor case
13. hub table
14. polygon mirror
15. retaining spring
16. metal shaft bearing
20. drive circuit
21. magnetic flux sensing section
22. FG sensor section
23. PG sensor section
24. frequency dividing circuit
25. timing circuit
26. drive motor section

What is claimed:

1. A polygon mirror drive motor for rotary driving of a polygon mirror, comprising:
a frequency generation magnetized section, in which an N pole part and an S pole part are alternately placed regarding magnetization and which rotates together with a rotor;
a frequency generation pattern being arranged so as to face the frequency generation magnetized section in an opposite position; and
a frequency dividing circuit for outputing a signal after a frequency dividing operation of an input signal;
said frequency dividing circuit outputting a signal detected by the frequency generation pattern after the frequency dividing operation of the signal for the number of mirror planes of the polygon mirror.

2. The polygon mirror drive motor according to claim 1,
wherein the frequency dividing circuit includes a logic circuit, in which a plurality of D-type flip-flop circuits are connected in series, and
in said logic circuit, data according to the signal detected by the frequency generation pattern are shifted cyclically so as to output the signal after the frequency dividing operation.

3. The polygon mirror drive motor according to claim 1,
wherein the polygon mirror drive motor further comprises:
a position detection magnetized section placed onto the rotor;
a position detection device arranged so as to face the position detection magnetized section in an opposite position; and
a timing circuit that controls start of timing of the frequency dividing operation of the frequency dividing circuit according to a signal detected by the position detection device.

4. The polygon mirror drive motor according to claim 3,
wherein the timing circuit is composed of a differential circuit with a resistor and a condenser.

5. A laser mirror radiation device, comprising the polygon mirror drive motor according to claim 1.

6. A polygon mirror drive motor for rotary driving of a polygon mirror, comprising:
a frequency generation magnetized section, in which an N pole part and an S pole part are alternately placed regarding magnetization and which rotates together with a rotor; and
a frequency generation pattern being arranged so as to face the frequency generation magnetized section in an opposite position;
wherein a frequency of the signal detected by the frequency generation pattern is equal to the number of the mirror planes of the polygon mirror.
